(19) United States
(12) Patent Application Publication
(10) Pub. No.: US 2005/0196615 A1
(43) Pub. Date: Sep. 8, 2005

(54) Substrate having insulating layers to prevent it from warping

(76) Inventors: Tsung-Neng Liao, Taichung County (TW); Francis Chung Hwa Pan, Taichung Hsien (TW); John Chungteh Pan, Taichung City (TW); Chun-Chi Lee, Taipei City (TW)

Correspondence Address: BIRCH STEWART KOLASCH & BIRCH, PO BOX 747, FALLS CHURCH, VA, 22040-0747, US

(21) Appl. No.: 10/791,819

(22) Filed: Mar. 4, 2004

(51) Int. Cl. G02F 1/1335; B32B 27/36

(52) U.S. Cl. 428/412; 428/500

(57) ABSTRACT

A substrate has a substrate member, which is made of Polymethyl methacrylate (PMMA) or Polycarbonate (PC), having a first side and a second side. On the fist side and the second side of the substrate member provided with an insulating layers respectively, wherein the insulating layers are made of Cyclic Olefins Polymer (COP). The water absorption of COP is less than the water absorption of PMMA and PC to prevent the substrate member from warping while the substrate is heated at a single side.

### BACKGROUND OF THE INVENTION

1. Field of the Invention

The present invention relates generally to an optical device, and more particularly to a substrate, which has insulating layers thereon to prevent the substrate from warping.

2. Description of the Related Art

FIG. 1 shows a direct-light backlight unit 60 and the backlight unit 60 has a base frame 62 on which a reflector 64, lamps 66, a diffuser 68 and a cover 70 are mounted in sequence.

The conventional diffuser 68 is made of Polymethyl methacrylate (PMMA) or Polycarbonate (PC) that the materials have a greater water vapor permeability. In a standard test of ASTM D570, the water absorption of PMMA is 0.3% and the water absorption of PC is 0.2%.

As shown in FIG. 2, the diffuser 68 has a first side 681, which is a side oriented to the lamps 66, and a second side 682, which is a side opposite to the first side 681, and the water permeated in the diffuser 68 are shown as dots in FIG. 2. As shown in FIG. 3, while the lamps 66 are turned on, the first side 681 of the diffuser 68 is exposed in the light of the lamps 66 directly and the permeable water in the diffuser 68 at where adjacent to the first side 681 is evaporated to escape from the diffuser 68 via the first side 681. In such condition, the diffuser 68 has a greater vapor permeability at where adjacent to the second side 682 and a less vapor permeability at where adjacent to the first side 681. In other words, the diffuser 68 has various material properties at the fist side 681 and at the second side 682. In additional, the lamps 66 irradiate the fist side 681 of the diffuser 68 directly to make the temperature at the first side 681 is greater than the temperature at the second side 682. Both factors of the material property and the temperature variety at the fist side 681 and the second side 682 of the diffuser 68 make the diffuser 68 warping as shown in FIG. 4.

A simple solution for such problem is that the diffuser is made of a material having a less water vapor permeability. But such material is rather too expensive or the material property thereof not meeting the requirement of the diffuser.

Another solution is to coat films that have a less water absorption on both sides of the diffuser. Typically, such films are made of silicon dioxide (SiO₂). The required temperature of coating the silicon dioxide films on the diffuser is very high (typically higher than 220° C.) and the coating process must be taken in a vacuum chamber. Such process is difficult and expensive, and more particularly, the high temperature would affect the material property of PMMA or PC.

### SUMMARY OF THE INVENTION

The primary objective of the present invention is to provide a substrate, which will not warp while the substrate is heated on a single side thereof.

The secondary objective of the present invention is to provide a substrate, which the process of fabricating the substrate is easier and under a lower temperature than the conventional process.

According to the objectives of the present invention, a substrate having a substrate member and insulating layers provided on both sides of the substrate, wherein the insulating layers are made of Cyclic Olefins Polymer (COP), which has a less water vapor permeability.

### BRIEF DESCRIPTION OF THE DRAWINGS

FIG. 1 is an exploded view of a conventional direct-light backlight unit;

FIG. 2 is a sectional view of the diffuser of the direct-light backlight unit and the lamps, wherein the lamps are off;

FIG. 3 follows FIG. 2, showing the lamps being turned on to evaporate water in the diffuser;

FIG. 4 follows FIG. 3, showing the diffuser warped because the temperature variety on both sides thereof;

FIG. 5 is a sectional view of a first preferred embodiment of the present invention;

FIG. 6 is a sectional view of the first preferred embodiment of the present invention, showing how the insulating layer blocks the water in the substrate member from escaping, and

FIG. 7 is a sectional view of a second preferred embodiment of the present invention.

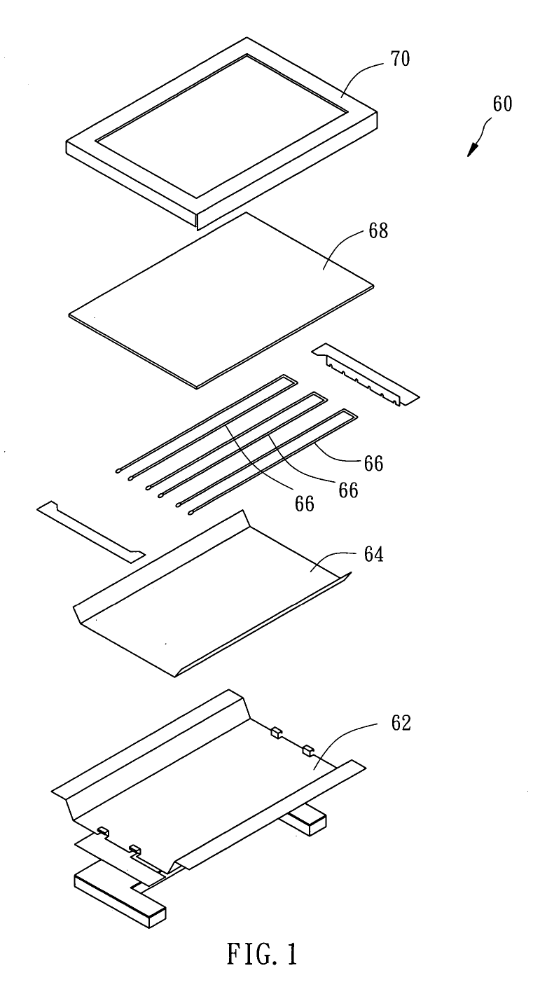

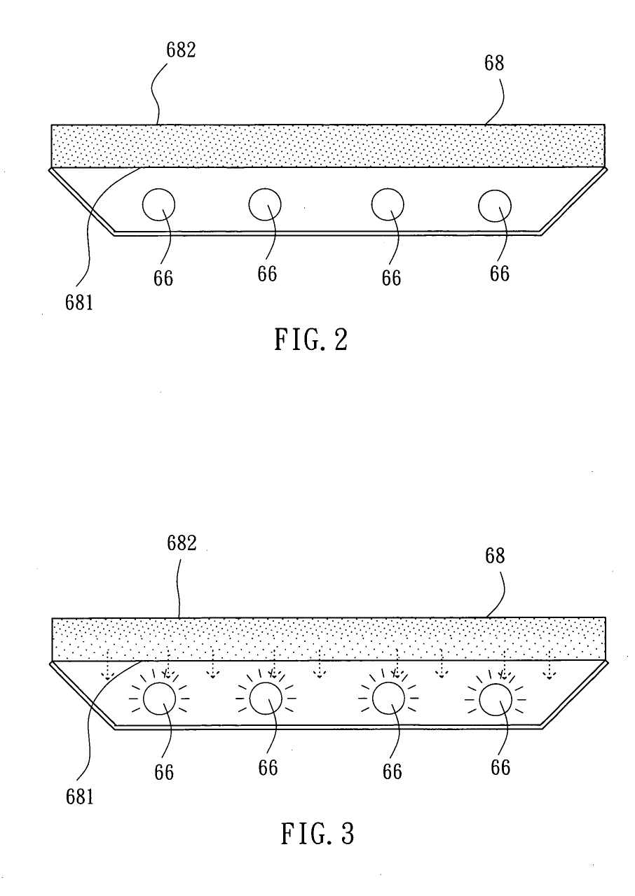

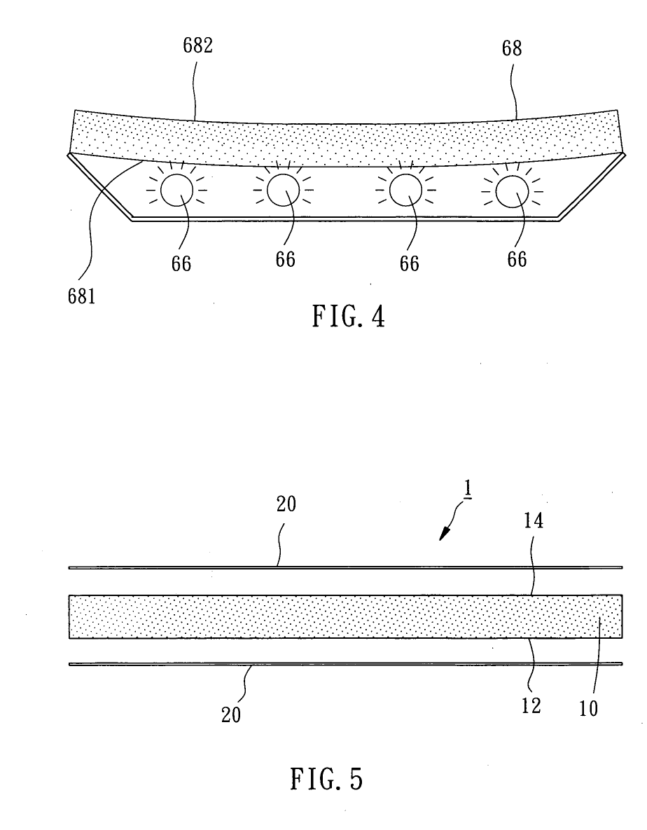

### DETAILED DESCRIPTION OF THE INVENTION

As shown in FIG. 5, the first preferred embodiment of the present invention provides a substrate 1 comprises a substrate member 10 having a first side 12 and a second side 14 and two insulating layers 20 provided on the fist and the second sides 12 and 14 of the substrate member 10 respectively.

The substrate member 10 is made of Polymethyl methacrylate (PMMA) or Polycarbonate (PC). PMMA is broadly applied to modern life because that it is superior in optical property thereof and is cheap. PC has superior properties in strength and in high transparent. Both of PMMA and PC are broadly applied to conventional automobile industry and architecture, furthermore, they are applied to compact discs, optical fibers, light guild plates or diffusers in the backlight units and other optical devices.

The insulating layers 20 are made of Cyclic Olefins Polymer (COP), and more particularly, the insulating layers 20 are made of Cyclic Olefins Copolymer (COC).

COC is synthesized (with Metallocene catalysts and MAO co-catalyst) by a co-polymerization process that reactants include cyclic olefins (ex. Noborene) and a-olefins (ethylene) monomers. This thermoplastic have several special properties including clear and colorless, absorb almost no moisture and highly impermeable to water, low shrinkage, low birefringence, high thermal resistance, good dimension stability, low dielectric constant and excellent resistance to aqueous acids, bases or polar organics. The water absorption of COC, under the standard test of ASTM D570, is less than 0.01% that is less than the water absorption of PMMA (0.3%) and PC (0.2%).

The methods of how to provide the insulating layers 20 on the substrate member 10 have co-extrusion method, coating method and evaporation method etc. The coating method has dip coating, slit coating and spin coating. The evaporation method has chemical vapor deposition (CVD) and physical vapor deposition (PVD).

To achieve the scope of the present invention, the insulating layers 20 must have a thickness greater than 1 μm, and preferable, the thickness of the insulating layers 20 is between 50 μm-200 μm.

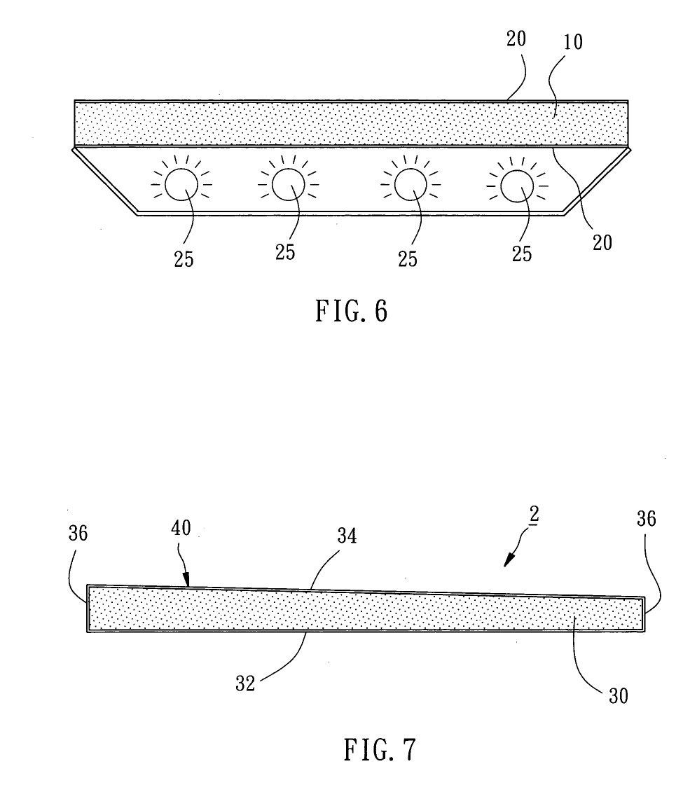

As shown in FIG. 6, a single side of the substrate 1 of the present invention, which is the first side 12 of the substrate member 10 shown in FIG. 6, is heated by lamps 25 (or other heat sources). The insulating layer 20 block the water permeable water in the substrate member 10 to prevent them from being evaporated and escaping out of the substrate member 10. Such that, the substrate 1 of the present invention keeps a homogeneous material property even if the substrate 1 is heated at a single side. As a result, the substrate 1 will not be warped while the temperature at a side of the substrate 1 is higher than the other side thereof.

As shown in FIG. 7, a substrate 2 of the second preferred embodiment of the present invention is illustrated as a light guild plate and the substrate 2 has a substrate member 30 having a first side 32, a second side 34 and four edge sides 36. FIG. 7 only shows two of the edge sides 36 at left and right sides but the edge sides at front and rear sides are not shown. On the first side 32, the second side 34 and the edge sides 36 of the substrate member 30 are provided with an insulating layer 40 respectively.

The substrate of the present invention can be applied to the diffuser of the direct-light backlight unit, the light guild plate of the edge-light backlight unit, the protective plate of the window, the optical lens and the plate of architecture.

1. A substrate, comprising
a substrate member having a first side and a second side;
a first insulating layer being on the first side of the substrate member; and
a second insulating layer being on the second side of the substrate member, the first and second insulating layers being made of Cyclic Olefins Polymer, when the substrate member is heated, the first and second insulating layers keeping water in the substrate member from escaping from the substrate member.

2. The substrate as defined in claim 1, wherein the first and second insulating layers are made of Cyclic Olefins Copolymer.

3. (canceled)

4. The substrate as defined in claim 1, wherein the first and second insulating layers have a thickness greater than 1 μm.

5. The substrate as defined in claim 1, wherein the first and second insulating layers have a thickness in a range of between 50 μm to 200 μm.

6. The substrate as defined in claim 1, wherein the substrate member further has edge sides, a third insulating layer being provided on the edge sides.

7. The substrate as defined in claim 1, wherein the substrate member is made of a material selected from Polymethyl methacrylate and Polycarbonate.

8. The substrate as defined in claim 1, wherein the first insulating layer contacts the first side of the substrate member and the second insulating layer contacts the second side of the substrate member.

9. A backlight unit, comprising:
a diffuser having a first side and a second side;
a first insulating layer being on the first side of the diffuser; and
a second insulating layer being on the second side of the diffuser, the first and second insulating layers being made of Cyclic Olefins Polymer; and
a lamp, when the diffuser is heated by the lamp, the first and second insulating layers keeping water in the diffuser from escaping from the diffuser.

10. The backlight unit of claim 9, wherein the first insulating layer contacts the first side of the diffuser and the second insulating layer contacts the second side of the diffuser.

11. The backlight unit of claim 9, wherein the first and second insulating layers are made of Cyclic Olefins Copolymer.

12. The backlight unit of claim 9, wherein the first and second insulating layers have a thickness greater than 1 μm.

13. The backlight unit of claim 9, wherein the first and second insulating layers have a thickness in a range of between 50 μm to 200 μm.

14. The backlight unit of claim 9, wherein the diffuser further has edge sides, a third insulating layer being provided on the edge sides.

15. The backlight unit of claim 9, wherein the diffuser is made of a material selected from Polymethyl methacrylate and Polycarbonate.
